(19) United States
(12) Patent Application Publication
(10) Pub. No.: US 2026/0311091 A1
(43) Pub. Date: Oct. 8, 2026

(54) MULTI-OBJECTIVE OPTIMIZATION OF GENERATIVE AI FLOWS

(71) Applicant: DataRobot, Inc., Boston, MA (US)

(72) Inventors: Stefan Hackmann, Immenstadt i. Allgäu (DE); Alexander Jason Conway, Newton, MA (US); Mikalai Valynets, Munich (DE); Michael Schmidt, Washington, DC (US); Debadeepta Dey, Seattle, WA (US); Mark L. Steadman, Watertown, MA (US)

(73) Assignee: DataRobot, Inc., Boston, MA (US)

(21) Appl. No.: 19/573,978

(22) Filed: Mar. 20, 2026

Related U.S. Application Data
(60) Provisional application No. 63/775,836, filed on Mar. 21, 2025.

(51) Int. Cl. G06Q 10/0631; G06Q 10/04

(52) U.S. Cl. CPC G06Q 10/06316; G06Q 10/04

(57) ABSTRACT

Constructing AI flows involves navigating a large number of choices of components including vector databases, embedding models, text splitters, retrievers, and synthesizing LLMs. The complexity further escalates with the introduction of advanced agentic and non-agentic paradigms that involve additional components including verifiers, rewriters, and re-rankers, each with intricate hyperparameter options. These choices pose significant challenges in optimizing for tradeoffs between objectives such as latency, accuracy, and cost. To address these challenges, the systems and methods of the present disclosure conduct an efficient multi-objective search across an extensive space of agentic and non-agentic AI flows (e.g., RAG-based AI flows). Leveraging advances in Bayesian Optimization, the multi-objective search can, in some examples, identify high-performing (e.g., Pareto-optimal) flows that by definition cannot be improved upon in selected objectives (e.g., task accuracy and/or latency) without sacrificing on one of the objectives.

### CROSS-REFERENCE TO RELATED APPLICATIONS

This disclosure claims benefit of U.S. Provisional Patent Application No. 63/775,836, filed on Mar. 21, 2025, which is hereby incorporated by reference in its entirety.

### BACKGROUND

This disclosure relates generally to artificial intelligence (AI) workflows (also referred to as “AI flows”), and more particularly to automated parameter optimization for generative AI flows. AI workflows generally refer to end-to-end computational pipelines that orchestrate data ingestion, preprocessing, model selection, training, validation, deployment, and/or monitoring to produce automated or semi-automated intelligent functionality. Such workflows often include multiple interdependent tasks executed across heterogeneous computing resources, frameworks, and data sources, and their performance may depend on numerous configurable parameters, execution orderings, and runtime conditions.

### SUMMARY

According to an aspect of the present disclosure, a computer-implemented method comprises performing multi-objective optimization over a hierarchically-organized search space comprising a plurality of candidate generative AI flow configurations.

According to another aspect of the present disclosure, a computing device comprises a processor and a non-transitory computer-readable medium storing instructions that, when executed by the processor, cause the processor to perform operations comprising obtaining a search space comprising a plurality of candidate generative AI flow configurations, wherein each candidate generative AI flow configuration comprises a flow type selected from a set of flow types and a set of hyperparameters based on the selected flow type, performing multi-objective Bayesian optimization over the search space by iteratively (i) selecting a candidate flow configuration to evaluate based on previously obtained objective values, and (ii) evaluating the selected candidate flow configuration against a plurality of objective functions to generate a set of objective values for the selected candidate flow configuration, updating a frontier based on the set of objective values generated for each evaluated candidate flow configuration, and configuring a generative AI pipeline in accordance with a flow configuration selected from the frontier.

According to another aspect of the present disclosure, a non-transitory computer-readable medium stores instructions that, when executed by a processor, cause the processor to perform operations comprising obtaining a search space comprising a plurality of candidate generative AI flow configurations, wherein each candidate generative AI flow configuration comprises a flow type selected from a set of flow types and a set of hyperparameters based on the selected flow type, performing multi-objective Bayesian optimization over the search space by iteratively (i) selecting a candidate flow configuration to evaluate based on previously obtained objective values, and (ii) evaluating the selected candidate flow configuration against a plurality of objective functions to generate a set of objective values for the selected candidate flow configuration, updating a frontier based on the set of objective values generated for each evaluated candidate flow configuration, and configuring a generative AI pipeline in accordance with a flow configuration selected from the frontier.

The foregoing is a non-limiting summary of the invention, which is defined by the attached claims.

### BRIEF DESCRIPTION OF THE DRAWINGS

These and other aspects and features of this disclosure will become apparent to those ordinarily skilled in the art upon review of the following description of specific implementations in conjunction with the accompanying figures, wherein:

FIG. 1 is a block diagram of a system architecture for multi-objective optimization of AI flows, in accordance with one or more embodiments.

FIG. 2 is a block diagram illustrating a multi-objective flow optimization process including candidate flow evaluation, frontier updating, and early stopping, in accordance with one or more embodiments.

FIG. 3 is a block diagram of a system for implementing the optimization architecture of FIG. 1, in accordance with one or more embodiments.

FIG. 4 is a block diagram of a hierarchical search space of generative AI flow configurations.

FIG. 5 is a diagram illustrating a confidence interval analysis, in accordance with one or more embodiments.

FIG. 6 is a scatter plot illustrating a Pareto frontier of evaluated candidate flow configurations in an accuracy-versus-cost objective space, in accordance with one or more embodiments.

FIG. 7 is a flowchart of an example process for identifying generative AI flow configurations (e.g., Pareto-optimal generative AI flow configurations) using multi-objective Bayesian optimization, in accordance with one or more embodiments.

FIG. 8 is a flowchart of an example process for evaluating candidate generative AI flow configurations using confidence-interval-based early stopping, in accordance with one or more embodiments.

FIG. 9 is a block diagram illustrating a computing device, in accordance with one or more embodiments.

### DETAILED DESCRIPTION

AI flows are structured workflows that process inputs using AI models to produce useful outputs. AI flows may involve various components, such as data retrieval, transformation, and generation, and can be optimized for specific objectives. AI workflow optimization tools generally seek to improve one or more operational objectives of these workflows (e.g., model accuracy, computational efficiency, latency, resource utilization, scalability, robustness, cost, etc.) by systematically adjusting workflow structure, parameters, scheduling, or execution strategies. Conventional approaches to managing and optimizing AI workflows frequently rely on manual tuning, static configurations, or heuristic rules, which can be inefficient, error-prone, and inadequate for dynamically changing workloads or environments. Thus, historically, the process used to optimize AI flows has been expensive and time-consuming, often requiring the expertise of multiple highly-trained individuals.

Optimizing an AI flow is highly challenging due to the vast combinatorial search space of possible configurations (e.g., flow structures and hyperparameter values), including choices for embedding models, retrievers, re-rankers, text splitters, and synthesizing large language models (LLMs), each with numerous hyperparameters. Even utilizing the expertise of highly-trained individuals, human intuition is often insufficient for navigating the complex dependencies between components, let alone selecting, deploying, and/or testing combinations of components. As new models and tools emerge, manual optimization struggles to keep pace, making it difficult to maintain consistently high-performing AI applications. As a result, such AI applications experience mounting inefficiencies, excessive compute costs, and suboptimal performance.

Systems and methods of the present disclosure can improve AI flow optimization by systematically and efficiently carrying out the search for high-performing (e.g., optimal, Pareto-optimal, etc.) generative AI flows (e.g., using multi-objective Bayesian optimization techniques), while reducing the reliance of optimization tools on human supervision or manual intervention. Systems and methods of the present disclosure can efficiently explore a vast space of possible configurations, considering trade-offs between flow attributes such as accuracy, latency, cost, throughput, reliability, and/or trust, among other variables, thereby conserving vast amounts of computational resources (compared to more exhaustive search techniques) and yielding better-performing AI flows (compared to the AI flows produced using optimization techniques that rely on heuristics and human intuition).

Unlike manual tuning, systems and methods of the present disclosure can systematically evaluate different flow components (e.g., embedding models, retrievers, re-rankers, synthesizing LLMs, etc.) and, in some embodiments, can use data-driven, efficiency enhancing techniques to limit the computational overhead (and duration) of the evaluation process. Some non-limiting examples of efficiency-enhancing techniques may include an early-stopping mechanism, data-driven seeding of the search (e.g., based on meta-learning), and caching of results of tasks that may be re-used in the evaluation of multiple different configurations, among others. Additionally, systems and methods of the present disclosure support hierarchical search so that aspects of a configuration that are likely to have a high impact on the attributes of the flow (e.g., the type of flow, the generative model used for synthesizing flow, the embedding model and retrieval technique used for retrieval-augmented generation (RAG), the type of fine-tuning performed on the generative model (e.g., direct preference optimization or “DPO”), etc.) may be prioritized. By integrating domain-specific optimizations and seeding techniques, systems and methods of the present disclosure may accelerate the optimization process and help AI developers quickly identify the most efficient and cost-effective AI pipelines.

Existing automated optimization approaches developed for machine learning (e.g., AutoML, neural architecture search) do not directly address the challenges unique to generative AI flow optimization. First, generative AI flow optimization may operate at inference time rather than training time. The models within a flow are pre-trained and are invoked as-is, and the relevant cost metric is the per-query inference cost (e.g., cost per token generated or per embedding computed) rather than a training-time heuristic such as training duration. Second, generative AI flows may depend on a grounding corpus (e.g., a document collection for retrieval-augmented generation) in addition to the processing pipeline itself. The interaction between the grounding corpus and flow configuration (e.g., how documents are split, embedded, retrieved, and presented to the synthesizing LLM) introduces dependencies that have no clear analogue in conventional ML pipeline optimization. Third, conventional AutoML methods are designed for pipelines that process structured, numeric data, whereas generative AI flows operate over unstructured text, requiring evaluation methods such as LLM-based judging that are themselves costly and stochastic. Fourth, evaluating a poorly performing generative AI flow configuration to completion is cost-prohibitive because each evaluation instance may invoke multiple LLM and embedding model calls, making early-stopping mechanisms a factor for practical search. Fifth, generative AI flows may utilize shared external model services (e.g., cloud-hosted LLM inference endpoints), which can become overloaded if too many candidate evaluations access them concurrently, requiring resource-aware scheduling during the search.

Some non-limiting examples of systems and methods for optimization (e.g., multi-objective optimization) of generative AI flows are described in the present disclosure. In some examples, types of generative AI flows may include a non-RAG flow (a flow that does not use RAG) and various RAG-based flows (flows that use RAG). Other types of generative AI flows may be evaluated, including (without limitation) content generation flows (e.g., image-generation flows), and user-specified flows, among others.

In some examples, in addition to identifying a set of flow configurations on the Pareto frontier for a particular domain, the systems and methods described herein may perform prompt optimization for one or more configurations (e.g., for the configurations on the Pareto frontier). In some examples, prompt optimization is performed using text gradients.

The present implementations will now be described in detail with reference to the drawings, which are provided as illustrative examples of the implementations so as to enable those skilled in the art to practice the implementations and alternatives apparent to those skilled in the art. Notably, the figures and examples below are not meant to limit the scope of the present implementations to a single implementation, but other implementations are possible by way of interchange of some or all of the described or illustrated elements. Moreover, where certain elements of the present implementations can be partially or fully implemented using known components, only those portions of such known components that are necessary for an understanding of the present implementations will be described, and detailed descriptions of other portions of such known components will be omitted so as not to obscure the present implementations. Implementations described as being implemented in software should not be limited thereto, but can include implementations implemented in hardware, or combinations of software and hardware, and vice-versa, as will be apparent to those skilled in the art, unless otherwise specified herein. In the present specification, an implementation showing a singular component should not be considered limiting; rather, the present disclosure is intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present implementations encompass present and future known equivalents to the known components referred to herein by way of illustration.

Embodiments can automatically select, configure, and/or optimize AI flows (including generative AI flows), which may correspond to a request received via the user interface and/or client device. A system can, for example, automatically determine an optimal Retrieval-Augmented Generation (RAG) or non-RAG workflow based on one or more characteristics of the requested task, data constraints, and/or performance objectives, including accuracy, latency, cost, and any other suitable consideration. For example, the system can dynamically identify and configure an optimal combination of embedding models, retrievers, re-rankers, and/or synthesizing LLMs for an AI assistant that balances a set of predetermined objectives, such as cost and response time. The system can include or access multiple generative AI models, retrieval mechanisms, optimization frameworks, metadata, application programming interfaces (APIs), and/or any other resource to automatically execute a set of computer-readable instructions to construct, evaluate, and/or deploy an optimized AI workflow tailored to specified constraints and/or objectives.

Testing and results can be found in Alexander Conway, et al., “Syftr: Pareto-Optimal Generative AI,” arXiv: 2505.20266 (2025), which is hereby incorporated by reference in its entirety.

### Generative AI (“Gen AI”) and Deep Learning (DL)

Gen AI technology generally utilizes generative models such as Generative Adversarial Networks (GANs), transformer-based models, diffusion models (e.g., stable diffusion models), and/or Variational Autoencoders (VAEs), etc., which are based on artificial neural networks and deep learning. Deep Learning (DL) is a subset of machine learning (“ML”) that focuses on artificial neural networks (ANN) and their ability to learn and make decisions. Deep Learning involves the use of complex algorithms to train ANNs to recognize patterns and make predictions based on large amounts of data. The key difference between DL and traditional ML algorithms is that DL algorithms can learn multiple layers of representations, allowing them to model highly nonlinear relationships in the data. This makes them particularly effective for applications such as image and speech recognition, natural language processing (NLP), etc.

Most DL methods use ANN architectures, which is why DL models are often referred to as deep neural networks (DNNs). The term “deep” refers to the number of hidden layers in the neural network. For example, a traditional ANN may only contain 2-3 hidden layers, while DNNs can have as many as 150 layers (or more). DL uses these multiple layers to progressively extract higher-level features from the raw input. For example, in image processing, lower layers may identify edges, while higher layers may identify the concepts relevant to a human, such as digits, letters, or faces. DL models are trained by using large sets of labeled data and ANN architectures that learn features directly from the data without the need for manual feature extraction.

### Hyperparameters and Hyperparameter Tuning

Hyperparameters are external configuration variables that control or guide machine learning model training. In other words, hyperparameters are parameters that control the learning process and thereby influence the ultimate structure of the model and the learned values of the model parameters. Many hyperparameters are used to guide the training of DNNs, such as the size (number of layers and number of units per layer), the learning rate (e.g., a tuning parameter in an optimization algorithm that determines the step size at each iteration while moving toward a minimum of a loss function), and initial weights of model parameters.

The term “hyperparameter” as used herein may encompass parameters that govern any stage of a generative AI workflow, including inference-time and workflow-level parameters in addition to training-time parameters. For example, inference-time hyperparameters of a language model may include a temperature parameter, a top-p parameter, and a maximum token length parameter. Workflow-level hyperparameters may include the number of documents retrieved from a vector database (top-k), the chunk size and overlap used by a text splitter, the selection of an embedding model, the selection of a retriever type, and the selection of a prompt template, among others. Unlike training hyperparameters, which influence the learned parameters of a model, these inference-time and workflow-level hyperparameters control how pre-trained models are invoked and composed within a generative AI flow.

The process of training an ANN involves choosing hyperparameter values that control and guide the learning algorithm. The process of experimenting with different hyperparameter values to find a suitable or optimum hyperparameter set is known as hyperparameter tuning or hyperparameter optimization. Hyperparameter tuning is an important aspect of developing ML tools and AI systems because the selected set of hyperparameters can have a significant impact on model performance and accuracy. For example, if the learning rate hyperparameter of an ANN training algorithm is too high, the model may converge too quickly with suboptimal results. On the other hand, if the learning rate is too low, training may take too long and results may not converge.

### Large Language Models (LLM) and Transformer Networks

In many generative AI (Gen AI) systems, the generative model that generates content is a large language model (LLM). An LLM is a type of ML model that can perform a variety of natural language processing (NLP) tasks such as generating and classifying text, answering questions in a conversational manner, and translating text from one language to another. The term “large” refers to the number of values (parameters) the language model can change autonomously as it learns. Some LLMs have hundreds of billions of parameters. In general, LLMs are NN models that have been trained using deep learning techniques to recognize, summarize, translate, predict, and generate content using very large datasets.

Many state-of-the-art LLMs use a class of deep learning architectures called transformer neural networks (“transformer networks” or “transformers”). A transformer is a neural network that learns context and meaning by tracking relationships between data units, such as the words in a sentence. A transformer can include multiple transformer blocks, also known as layers. For example, a transformer may have self-attention layers, feed-forward layers, and normalization layers, all working together to decipher input to predict (or generate) streams of relevant output. The layers can be stacked to make deeper transformers and powerful language models.

Two innovations that make transformers adept for large language models: positional encodings and self-attention. Positional encoding embeds the order in which the input occurs within a given sequence. Rather than feeding words within a sentence sequentially into the neural network, with positional encoding, the words can be fed in non-sequentially. Self-attention assigns a weight to each part of the input data while processing it. This weight signifies the importance of that portion of the input in the context of the rest of the input. The use of the attention mechanism enables models to focus on the parts of the input that matter the most. This representation of the relative importance of different inputs to the neural network is learned over time as the model sifts and analyzes data. These two techniques in conjunction allow for analyzing the subtle ways and contexts in which distinct elements influence and relate to each other over long distances, non-sequentially. The ability to process data non-sequentially enables the decomposition of the complex problem into multiple, smaller, simultaneous computations.

“Text completion” may refer to the process of a generative model generating additional text based on provided text, e.g., providing the next word in a sentence. The additional text provided by the generative model may be referred to herein as a “completion.” More generally, completions generated by generative models may include text, audio data (e.g., speech, music, etc.), image data (e.g., images), video data (e.g., videos), time-series data, or any other suitable type of data. “Prompting” may refer to a technique in which a generative model (e.g., an LLM) is matched to a desired downstream task by formulating the task as natural language text explaining the desired behavior, such that a generative model can carry out the task by performing text completion. Often these instructions are split into a “system message” containing general task instructions providing general guidance about the desired behavior and a “prompt template” containing the portion of the prompt that contains indicator values that are substituted in each use. “Fine-tuning” may refer to the process whereby a generative model is adapted to a particular task by changing its parameters by providing prompts with desired completions.

Generative AI models can analyze existing content, identify patterns in the content, and combine or modify the identified patterns to generate new content. The new content can include text, images, video, music, or any other suitable type of content. Some non-limiting examples of generative AI models include generative adversarial networks (GANs), variational autoencoders (VAEs), autoregressive models (e.g., large language models (LLMs)), recurrent neural networks (RNNs), transformer-based models, reinforcement learning models for generative tasks, etc. Transformer-based models generally have an encoder-decoder architecture, use an attention mechanism (e.g., scaled dot-product attention, multi-head attention, masked attention, etc.) to model the relationships between different elements in a sequence of content, and perform well when processing long sequences of content. Some non-limiting examples of transformer-based models include Generative Pre-trained Transformer 4 (GPT-4), DALL-E3, etc. Other examples of generative models with text-processing capability include Jurassic-1, Command, and Paradigm. Generative models can benefit from hyperparameter tuning to tweak the model's performance for desired results, as discussed above.

Many of the examples and embodiments disclosed herein are described with respect to a knowledge base. However, the techniques described herein can be applied to any type of “grounding data” for generative AI systems (e.g., retrieval-augmented generation (RAG)-based generative AI systems) including but not limited to knowledge bases and/or other information sources.

The term “generative model” as used herein may generally refer to a type of machine learning model that is trained on existing data to enable the generative model to generate, based on an input or prompt, new data that shares characteristics similar to that of the training data. In some examples, a generative model may handle text. In these examples, the generative model may accept text prompts and produce text outputs. Any suitable type of AI model can be used, including predictive models, generative AI (“Gen AI”) models, etc. Predictive models can analyze historical data, identify patterns in that data, and make inferences (e.g., produce predictions or forecast outcomes) based on the identified patterns. Some non-limiting examples of predictive models include neural networks (e.g., deep neural networks (DNNs), convolutional neural networks (CNNs), recurrent neural networks (RNNs), learning vector quantization (LVQ) models, etc.), regression models (e.g., linear regression models, logistic regression models, linear discriminant analysis (LDA) models, etc.), decision trees, random forests, support vector machines (SVMs), naïve Bayes models, classifiers, etc.

### Some Embodiments

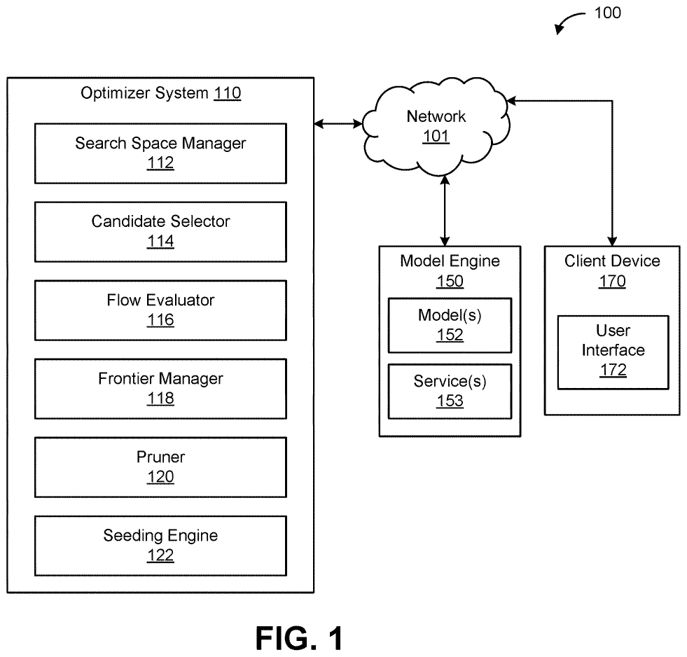

FIG. 1 is a block diagram of a system architecture 100 for multi-objective optimization of AI flows in accordance with one or more embodiments. The system architecture 100 can include or interface with one or more of an optimizer system 110, a network 101, a modeling engine 150, and/or a client device 170. As used herein, “multi-objective optimization” may refer to any process that improves or attempts to improve the performance of an AI flow with respect to two or more objectives or metrics (e.g., using statistical optimization techniques).

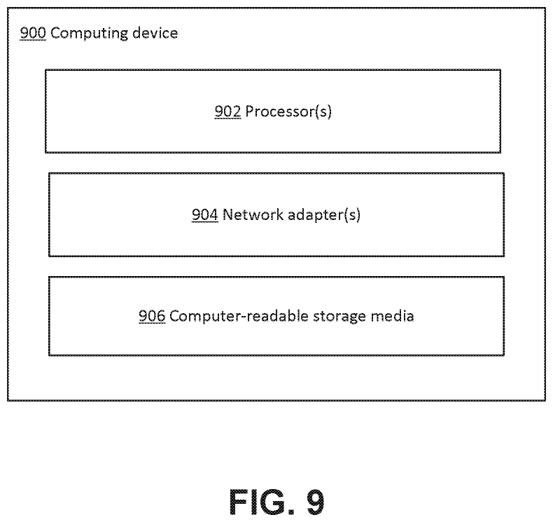

The optimizer system 110 may be configured to systematically search for the best generative AI flow configurations for a particular set of constraints and/or objectives. The optimizer system 110 may be implemented using one or more computing devices, such as the computing device 900 described below with reference to FIG. 9. The optimizer system 110 includes functional facilities (e.g., search space manager 112, candidate selector 114, flow evaluator 116, frontier manager 118, pruner 120, and/or seeding engine 122) that carry out the methods described herein. Each of the functional facilities described below may be implemented in software, hardware, firmware, or any combination thereof.

A search space manager 112 may define and maintain a search space comprising candidate generative AI flow configurations. Each candidate flow configuration specifies a flow type selected from a set of structurally distinct flow types, a set of hyperparameters based on the selected flow type, and values of the hyperparameters. The hyperparameter values may specify functional and/or structural properties for the candidate flow configuration (e.g., selections of functional facilities to be included in the candidate flow and/or values of configuration parameters of such functional facilities). The search space manager 112 stores the search space definition, including the set of available flow types, the available functional facility choices for each flow type, and/or the conditional hyperparameter ranges associated with each functional facility choice.

A candidate selector 114 may select candidate flow configurations to evaluate. In some examples, the candidate selector 114 performs an optimization (e.g., multi-objective Bayesian optimization) to select the candidate flow configurations to evaluate based on previously obtained objective values. In one embodiment, the candidate selector 114 uses Multi-Objective Tree-of-Parzen Estimators (MO-TPE), which model the likelihood of hyperparameters leading to good or poor performance using tree-structured conditional distributions. The candidate selector 114 may use an Expected Hypervolume Improvement (EHVI) acquisition function to guide exploration of the search space toward regions likely to improve the Pareto frontier. In another embodiment, the candidate selector 114 may use other optimization approaches, such as Gaussian process-based methods with multi-objective acquisition functions, or evolutionary strategies adapted for hierarchical search spaces.

A flow evaluator 116 may construct and evaluate candidate flow configurations. For a given candidate flow configuration, the flow evaluator 116 instantiates the specified flow by assembling the selected functional facilities with their associated hyperparameters, and evaluates the instantiated flow against an evaluation dataset to obtain a set of objective values. The evaluation dataset may comprise question-answer pairs, and evaluating may include generating a response using the candidate flow configuration and scoring the generated response against a ground-truth answer using a judge language model (or panel of judge language models). In some embodiments, the judge language model (or panel of models) is randomly selected for each evaluation instance from a set of available judge language models to provide diverse assessments.

A frontier manager 118 (e.g., Pareto frontier manager) may maintain and update a frontier (e.g., Pareto frontier) based on the objective values obtained for each evaluated candidate flow configuration. The Pareto frontier comprises a set of non-dominated flow configurations with respect to one or more competing objective functions. A flow configuration is non-dominated if no other evaluated configuration is better on all objectives. In one embodiment, the competing objective functions include task accuracy and operational cost. In other embodiments, the competing objective functions may additionally or alternatively include latency, reliability, throughput, correctness, or fairness, among others.

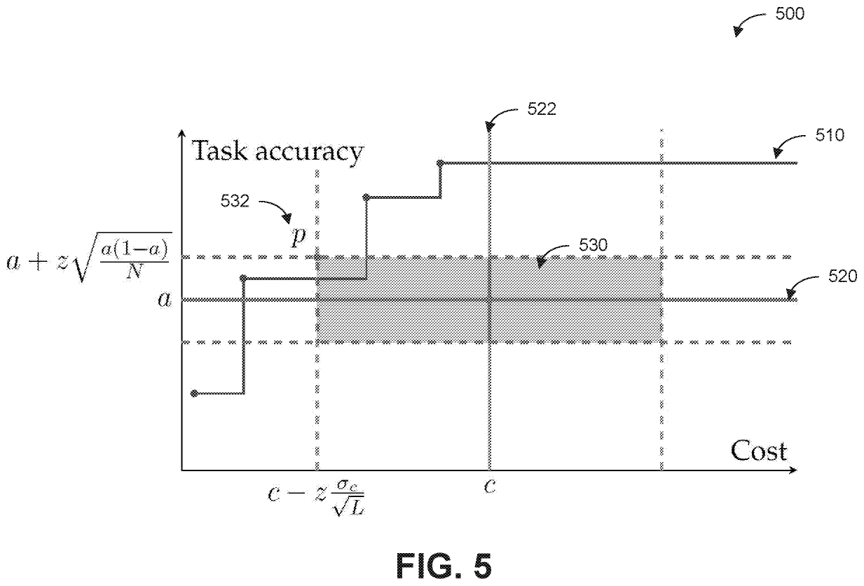

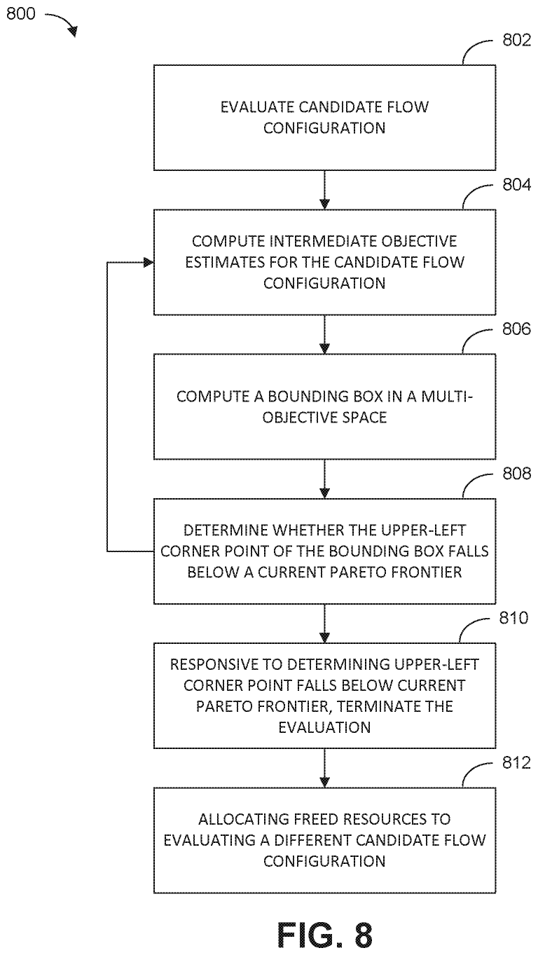

A pruner 120 (e.g., Pareto-Pruner) may perform early stopping of candidate flow evaluations. During evaluation of a candidate flow configuration by the flow evaluator 116, the pruner 120 receives intermediate evaluation results and determines whether the candidate has a reasonable chance of contributing to the current frontier. The operation of the pruner 120 is described in further detail below with reference to FIGS. 5 and 8.

A seeding engine 122 may seed the candidate selector 114 with initial flow configurations and their objective values prior to the start of an optimization process (e.g., multi-objective Bayesian optimization). The seeding engine 122 supports multiple seeding strategies. Static seeding uses a set of standard flow configurations obtained by enumerating combinations of selected functional facility choices, such as common pairings of synthesizing LLMs and embedding models. Random seeding generates flow configurations by randomly sampling from the hierarchical search space. Transfer seeding uses objective values obtained from a prior optimization performed on a different dataset to warm-start the optimization, enabling faster convergence on new datasets by leveraging knowledge from previously analyzed datasets. Meta-learning-based seeding uses flow configurations that have performed well empirically across a large variety of datasets. To identify such configurations, the seeding engine 122 aggregates the Pareto frontiers from multiple prior optimization runs, each performed on a different dataset, into a unified Pareto front by normalizing the objective values across datasets (e.g., scaling accuracy and cost values to a common range). The seeding engine 122 then selects flow configurations from the unified Pareto front for use as seed configurations.

The modeling engine 150 may host or otherwise provide access to the models and services used by the candidate flow configurations during evaluation and deployment. The modeling engine 150 includes one or models 152 such as synthesizing LLMs, embedding models, reranking models, judge LLMs, hypothetical document embedding (HyDE) models, among others. The modeling engine 150 may also include one or more services 153 such as vector databases, keyword-based retrieval indices (e.g., BM25 indices), and other retrieval or data-access services, among others. The optimizer system 110 communicates with the modeling engine 150 (e.g., via the network 101) to invoke these models during flow evaluation. In some embodiments, the modeling engine 150 includes one or more cloud-based inference services. In some embodiments, the modeling engine 150 includes locally hosted models served via dedicated inference infrastructure. The modeling engine 150 may be implemented as part of the optimizer system 110. Additionally or alternatively, the modeling engine 150 may be implemented using a computing device such as the computing device 900 described with reference to FIG. 9, and may be a desktop computer, a laptop computer, a tablet, a smartphone, or any other computing device with a display and network connectivity.

The client device 170 may include or provide a user interface 172 through which a user specifies optimization parameters, such as the objectives to optimize, the evaluation dataset, any constraints on the search, among others. The user interface 172 may accept input in a variety of different formats, such as through speech recognition, text input, or other means, as embodiments are not limited in this respect. The user interface 172 may also be used to provide and/or display data by the client device 170. The user interface 172 also presents the fronter (e.g., Pareto frontier) to the user, enabling the user to inspect the tradeoff surface and select an optimal (e.g., Pareto-optimal) flow configuration for deployment. The user interface 172 may be in any suitable format. In some examples, it may be a web interface, but embodiments are not so limited. Other embodiments may use a mobile application, software application, or other software, firmware, or other computer instructions. The client device 170 may be implemented using a computing device such as the computing device 900 described with reference to FIG. 9, and may be a desktop computer, a laptop computer, a tablet, a smartphone, or any other computing device with a display and network connectivity.

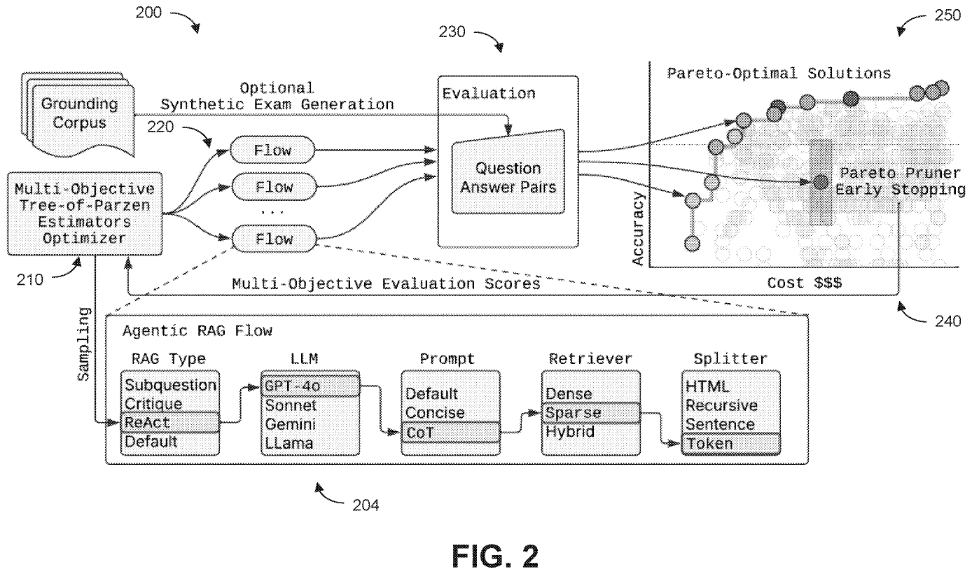

FIG. 2 is a block diagram of a multi-objective flow optimization process 200 in accordance with one or more embodiments. FIG. 2 provides an overview of an iterative optimization loop that may be performed by the optimizer system 110 of FIG. 1.

A multi-objective optimizer 210 (corresponding to the candidate selector 114) may sample a flow amongst the top-level flows, such as a RAG flow. In some embodiments, the multi-objective optimizer is an MO-TPE optimizer that uses weighted linear scalarization to convert multiple objectives into a single scalar objective for evaluation and an EHVI-based strategy to guide the search.

The optimizer system 110 may include a search space, which includes different AI flow types, such as agentic RAG flows 204 including ReAct agentic RAG flows (iterative reasoning and action-based retrieval workflows), critique agentic RAG flows (flows incorporating self-evaluation and refinement), subquestion agentic RAG flows (e.g., flows that break queries into multiple subquestions), among others. Each AI flow type includes a hierarchy of one or more configurable components, such as LLM, prompt, retriever, among others. Additionally, each configurable component may have one or more hyperparameter options, which may be unique to that component. The result is a combinatorial, hierarchically-organized search space including approximately 10²³ unique AI flows. In addition to the size of the search space, this search space poses a challenge because it is a domain where “function evaluation” is computationally expensive. That is, to evaluate each flow requires constructing and running each flow on an evaluation environment and evaluation dataset.

The multi-objective optimizer 210 may select candidate flow configurations from the hierarchical search space (which includes agentic RAG flows 204) based on previously obtained objective values. For a sampled AI flow type, the optimizer system 110 may sample each component in the hierarchy corresponding to the AI flow type, such as embedding models, retrievers, LLMs, hyperparameters, and/or any other configurable flow component.

Each selected candidate flow configuration may be instantiated as a flow 220. The flow 220 may be a non-agentic RAG flow or an agentic RAG flow that incorporates the non-agentic flow as a subroutine. The multi-objective optimizer 210 evaluates each flow 220 against an evaluation dataset including question-answer pairs 230. Evaluation may be performed via MO-TPE, which is a Bayesian optimization method that models the probability distributions of good versus bad configurations. MO-TPE may guide the search toward promising areas of the search space, balancing multiple objectives such as accuracy versus latency, accuracy versus cost, latency versus cost, and/or any other set of objectives. MO-TPE uses a weighted linear scalarization approach to convert multiple objectives into a single scalar objective for evaluation and an expected hypervolume improvement (EHVI)-based strategy to guide the search. EHVI measures the contribution of a new sample to the hypervolume dominated by the Pareto frontier, ensuring exploration of the most promising regions. Evaluation produces multi-objective evaluation scores 240 for the candidate, which may include an accuracy score and a cost value.

The evaluation scores 240 may be fed back to the multi-objective optimizer 210 to inform subsequent candidate selection, and are also used to update a set of optimal solutions 250 (e.g., Pareto-optimal solutions). The optimal solutions 250 represent the current frontier (e.g., Pareto frontier), which is the set of evaluated flow configurations for which no other evaluated configuration achieves simultaneously better values on all objectives. As shown in the figure, the optimal solutions 250 may be depicted as a scatter plot in an accuracy-versus-cost space, with optimal points (e.g., Pareto-optimal points) highlighted.

The multi-objective optimizer 210 (also corresponding to the pruner 120) may receive the intermediate evaluation results as flow instances are evaluated and perform early stopping when the candidate flow is unlikely to improve the current frontier (e.g., Pareto frontier). Computational resources freed by early stopping may be allocated to evaluate the next candidate flow configuration to improve the overall efficiency of the optimization process.

The process may be repeated over multiple trials, refining the search space based on prior evaluations. The multi-objective optimizer 210 may sample other flows based on past results, focusing on promising flow configurations while pruning unproductive flow configurations. After running a threshold number of trials, the multi-objective optimizer 210 may output the optimal flows (e.g., Pareto-optimal flows), meaning that the flows offer the best possible trade-offs between the competing objectives for the given dataset and task.

In some embodiments, the process 200 may include seeding the optimizer system 110 so that specific, commonly-used flows are included in the search space that is evaluated and to inject domain-specific knowledge of the search space so that the MO-TPE starts with a useful prior. Without seeding, the multi-objective optimizer 210 may not initially know that certain parameters (e.g., the LLM used for generation or the embedding model for creating vector databases) may be more impactful than others (e.g., the chunk size).

One approach to seeding is static seeding where the multi-objective optimizer 210 begins with a few widely used “standard” flow configurations, which may be obtained by looping over all possible values for certain components like the synthesizing LLM, embedding model. Another approach to seeding is dynamic transfer seeding where the multi-objective optimizer 210 performs a form of transfer learning. The multi-objective optimizer 210 may identify a predetermined number of the top frontier flows (e.g., top Pareto frontier flows) for each run of the process 200 from a list of prior search runs that used a different dataset than the current one. Then the multi-objective optimizer 210 computes embeddings of the corresponding flows (e.g., with BAAI/bge-large-en-v1.5 text embedding model), clusters the embeddings (e.g., with k-nearest neighbors), and selects a predefined number of configurations from the clusters such that flows from the same cluster are not selected together, to maximize diversity of the selected pool of flows. In some embodiments, meta-learning-based seeding aggregates the Pareto frontiers from a plurality of prior optimization runs performed on different datasets into a unified Pareto front. The seeding engine 122 selects flow configurations from the unified Pareto front that have demonstrated strong performance across multiple datasets, providing the candidate selector 114 with seed configurations that represent broadly effective starting points.

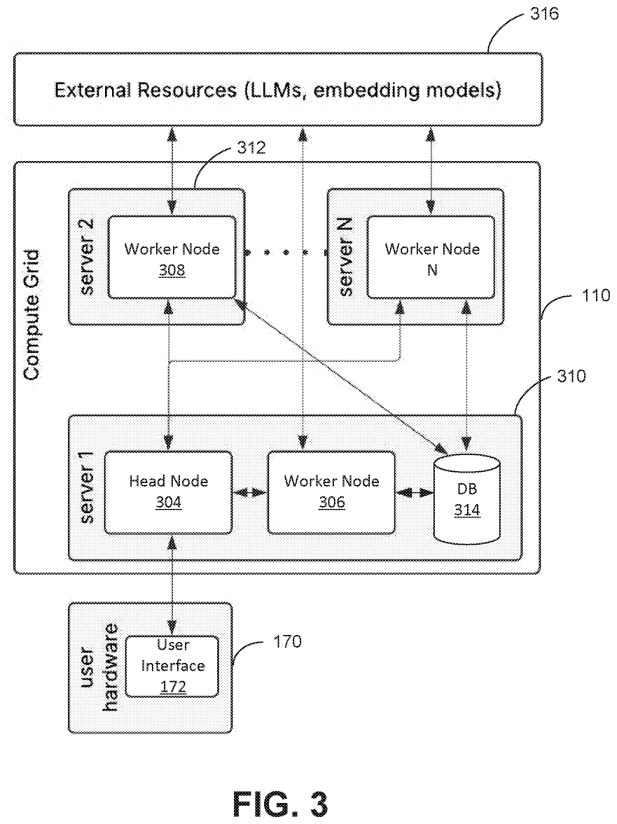

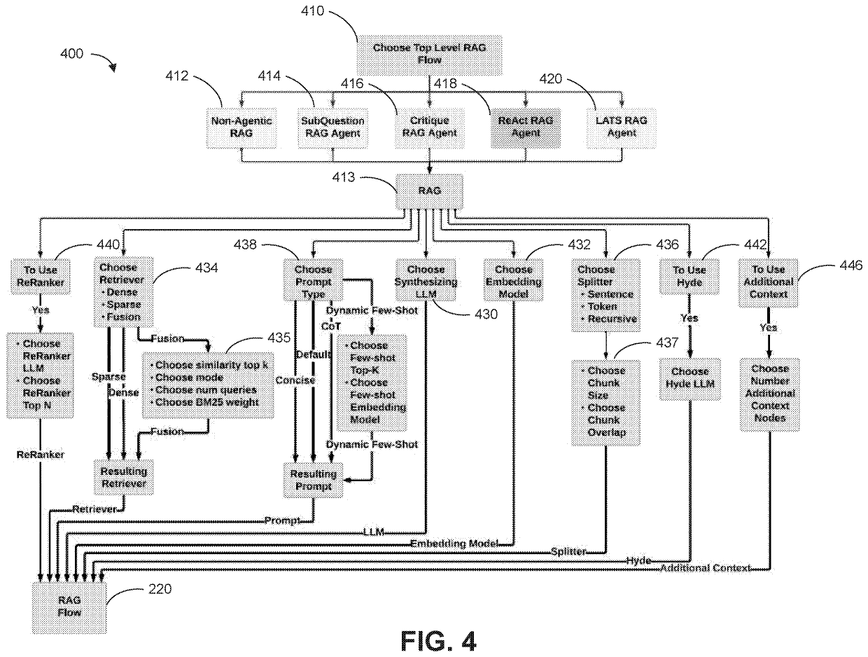

FIG. 3 is a block diagram an example architecture of the optimizer system 110, in accordance with one or more embodiments. The optimizer system 110 may include a compute cluster, which may include a plurality of computers (or “nodes”) that work together to provide a shared resource for computing, storage, and/or networking. The cluster may be managed by a head node 304 that coordinates the distribution of tasks, resources, and/or data across the nodes. The tasks that may be distributed among nodes may be individual AI flows corresponding to points in the search space (discussed below with regard to FIG. 4), thereby enabling the optimizer system 110 to efficiently explore multiple points in the search space in parallel. In addition to improved searching efficiency, the configuration also reduces cost for the use of external resources 316 in the form of cloud services or other hosted platforms that charge for usage time.

The head node 304 may assign tasks (or portions thereof) to worker nodes on a local server 310 (e.g., worker node 306) and/or to worker nodes (e.g., worker node 308) on remote servers (e.g., remote server 312). The worker nodes may run models locally and/or remotely (e.g., via API). The worker nodes may then return results back to the head node 304 for the head node 304 to aggregate results and assign further tasks. The worker nodes may also cache intermediate results (e.g., embeddings) in a database (e.g., DB 314), which may be on the local server 310, elsewhere in the optimizer system 110, and/or remote.

The DB 314 and the head node 304 can provide insights into the search process. The user can connect to the DB 314 for analysis, monitoring, etc., of the search process. The user can also connect to the head node 304, which has its own monitoring of the status of various tasks, error tracking, etc.

In some embodiments, while the optimizer system 110 may increase (e.g., maximize) utilization of certain external resources to reduce cost, the head node 304 may utilize locking and/or sleeping to limit overloading the external resources. If too many workers attempt to access an LLM platform at the same time, for example, the LLM platform can become overloaded and performance can degrade. To prevent this, the head node 304 may use locking mechanisms to limit the number of worker nodes that can access an LLM platform simultaneously or the number of access requests the worker nodes (individually or collectively) can submit to an LLM platform within a specified time period. The head node 304 may also or instead put some work nodes to “sleep” or idle, which prevents them from trying to access an LLM platform and allows other worker nodes to make progress with the LLM platform. The head node 304 may also or instead cause some worker nodes to utilize other LLM platforms if multiple are available and if the LLM platform they are attempting to use becomes overloaded. By keeping external resources (e.g., LLM platforms) from becoming overloaded, the head node 304 can maximize utilization of external resources while keeping the external resources responsive and scalable.

FIG. 4 is a block diagram of an example search space 400 of generative AI flow configurations. The search space 400 may be hierarchically-organized. The search space 400 may be defined and maintained by the search space manager 112 and serve as the domain over which the candidate selector 114 performs optimization (e.g., multi-objective Bayesian optimization).

At the top level, the hierarchical search space 400 may include a flow type selection 410 from a set of structurally distinct flow types. In the illustrated embodiment, the set of flow types includes a non-agentic RAG flow 412 and a plurality of agentic flow types including a sub-question decomposition agent 414, a critique agent 416, a reasoning-and-acting (ReAct) agent 418, and a language agent tree search (LATS) agent 420. Each agentic flow type may incorporate the non-agentic RAG flow 412 as a subroutine, adding agent-specific capabilities such as iterative reasoning, query decomposition, self-critique, or tree-structured planning, among others, on top of the base RAG pipeline. In other embodiments, the set of flow types may include additional or different flow types, such as content generation flows or image generation flows.

Below the flow type selection 410, the hierarchical search space 400 may specify a set of hyperparameters based on the selected flow type. For the non-agentic RAG flow 412, the hyperparameters include the following functional facility selections and their associated sub-hyperparameters.

A synthesizing LLM selection 430 may specify the model (e.g., language model) used to generate a response from the retrieved context. The set of available synthesizing LLMs may include models of varying sizes and capabilities, from smaller, lower-cost models to larger, higher-accuracy models, spanning multiple model providers.

An embedding model selection 432 may specify the model used to encode the grounding corpus and user queries into vector representations for storage in and retrieval from a vector database. The set of available embedding models may include models selected from an embedding benchmark leaderboard, with a focus on models optimized for retrieval tasks.

A retriever type selection 434 may specify the retrieval strategy. In the illustrated embodiment, the retriever type may be a dense retriever, a sparse retriever, or a fusion retriever. A dense retriever represents queries and documents as dense vectors in a continuous vector space and retrieves based on vector similarity. A sparse retriever, such as a BM25-based retriever, represents documents and queries as sparse vectors and retrieves based on keyword-based term matching. A fusion retriever combines results from both dense and sparse retrieval and fuses them using techniques such as reciprocal rank fusion. The retriever type selection 434 may include conditional hyperparameters 435 such as a top-k parameter specifying the number of results to retrieve, a number-of-queries parameter, a retrieval mode parameter, or a BM25-weight parameter controlling the balance between dense and sparse retrieval, among others.

A text splitter selection 436 may specify the method used to split the grounding corpus into chunks for embedding and storage. The splitter types include a recursive splitter that iteratively decomposes text from larger to smaller linguistic units, a token splitter that segments text into token-level units, and a sentence splitter that divides text at sentence boundaries, among others. The text splitter selection 436 may include associated chunk-size and/or chunk-overlap hyperparameters 437 that control the size of each chunk and the degree of overlap between adjacent chunks.

A prompt type selection 438 may specify the prompt template used to frame the query (e.g., evaluation query) and retrieved context for the synthesizing LLM. Available prompt types include a default prompt, a concise prompt that instructs the model to be brief, and a chain-of-thought (CoT) prompt that instructs the model to reason step-by-step before answering.

The hierarchical search space 400 may further include functional facility selections such as a reranker selection 440 specifying a reranking model and/or a top-N parameter, a HyDE selection 442 specifying a model (e.g., language model) used to generate a hypothetical document for improved retrieval, and an additional context selection 446 specifying additional context nodes to include.

For agentic flow types, the search space may inherit all of the RAG flow hyperparameters 413 (since the RAG flow serves as a subroutine) and additionally includes agent-specific hyperparameters. The hierarchical, conditional structure of the search space 400 means that a given candidate flow configuration occupies a specific path through the tree. The selected flow type determines which functional facility selections are active, and each functional facility selection determines which sub-hyperparameters are active. This results in a search space of approximately 10²³ unique flow configurations in the illustrated embodiment.

In some embodiments, the multi-objective optimizer 210 performs block-based optimization, in which the hyperparameters of the search space 400 are partitioned into a plurality of blocks, and the blocks are optimized sequentially. Each block comprises a subset of hyperparameters that may be optimized together while hyperparameters in other blocks are held fixed at default or previously determined values. Block-based optimization may reduce the effective dimensionality of the search space at each stage, improving sample efficiency.

The hierarchical structure of the search space 400 lends itself to block-based optimization because the hyperparameters are grouped by functional concern rather than arbitrarily organized. For example, a retrieval block may include hyperparameters related to retrieval-augmented generation, such as the retriever type selection 434, the embedding model selection 432, the text splitter selection 436 and its associated chunk-size and chunk-overlap hyperparameters 437, and the top-k parameter of the conditional hyperparameters 435. A prompting block may include hyperparameters related to prompting, such as the prompt type selection 438, few-shot configuration, and chain-of-thought settings. A synthesis block may comprise hyperparameters related to response generation, such as the synthesizing LLM selection 430 and its associated temperature and top-p parameters. By organizing hyperparameters into functionally coherent blocks, the multi-objective optimizer 210 can focus on related parameters together, capturing their interactions while reducing the overall search complexity.

In some embodiments, blocks may be hierarchically organized into blocks and sub-blocks to accommodate larger or more complex search spaces. For example, a retrieval block may comprise sub-blocks, such as an embedding sub-block (including the embedding model selection 432 and embedding-related hyperparameters), a retriever sub-block (including the retriever type selection 434, the top-k parameter, and fusion parameters), and a text splitting sub-block (including the text splitter selection 436, chunk-size, and chunk-overlap hyperparameters 437). This hierarchical block structure enables the multi-objective optimizer 210 to perform coarse-to-fine optimization, first optimizing across top-level blocks and then refining within sub-blocks as needed. Sub-blocks within a given block may be optimized sequentially in the same manner as top-level blocks, with hyperparameters in other sub-blocks held at fixed values during optimization of each sub-block.

In some embodiments, block-based optimization uses an expanding strategy, in which the set of searchable hyperparameters is progressively expanded with each block. For example, a first block containing high-impact hyperparameters (e.g., the flow type selection 410, the synthesizing LLM selection 430) may be optimized first, and then a second block containing additional hyperparameters (e.g., the embedding model selection 432, the retriever type selection 434) is added to the searchable set while retaining the hyperparameters from the first block. This process may continue until all blocks have been incorporated into the search.

In some embodiments, block-based optimization uses a knee-point strategy, in which after optimizing each block, the multi-objective optimizer 210 identifies a knee point on the current Pareto frontier maintained by the frontier manager 118. The knee point may represent a favorable trade-off between the competing objectives. The multi-objective optimizer 210 may use the hyperparameter values at the knee point as default values for subsequent blocks. This enables each subsequent block to build upon a high-performing configuration identified in prior blocks. The knee point may be identified by computing the point on the frontier that maximizes the trade-off ratio between competing objectives (e.g., the point of maximum curvature along the frontier), or may be selected by a user through the user interface 172.

In some embodiments, the blocks may be shuffled between optimization rounds to avoid bias toward any particular ordering. In some embodiments, multiple rounds of block-based optimization may be performed, revisiting blocks to refine the search.

FIG. 5 is a diagram illustrating a confidence interval analysis 500, in accordance with one or more embodiments. FIG. 5 illustrates the mechanism by which the pruner 120 determines whether to terminate evaluation of a candidate flow configuration.

FIG. 5 depicts a two-dimensional objective space with a task accuracy axis (vertical) and a cost axis (horizontal). A current Pareto frontier 510 is shown as a stepped line connecting non-dominated solutions from prior evaluations.

For a candidate flow configuration currently being evaluated, the pruner 120 computes intermediate objective estimates after processing fewer than all of the evaluation instances in the evaluation dataset. The intermediate objective estimates include an accuracy estimate a 520, depicted as a horizontal dashed line, and a cost estimate c 522, depicted as a vertical dashed line.

The pruner 120 computes a corresponding accuracy confidence interval and a corresponding cost confidence interval from the intermediate results. In one embodiment, the accuracy confidence interval is computed by fitting a normal distribution to the accuracy scores of the processed evaluation instances, and the cost confidence interval is computed by fitting a log-normal distribution to the cost values of the processed evaluation instances. Both confidence intervals may be computed at a confidence level of at least 90%.

The upper bound of the accuracy confidence interval is computed as a+z√(a(1−a)/N), where a is the average accuracy, N is the total number of evaluations including successful evaluations and errors, and z is a parameter representing the standard score for a normal distribution and controls the sensitivity of the pruner. The lower bound of the cost confidence interval is computed as c−z(σ_c/√L), where c is a percentile-based cost statistic (such as the P80 cost), σ_c is the standard deviation of costs, L is the number of successful evaluations, and z is a parameter representing the standard score for a normal distribution and controls the sensitivity of the pruner. The use of different distributional assumptions for accuracy and cost may reflect the different characteristics of these metrics. For example, accuracy is bounded in [0, 1] and approximately normally distributed, while cost is bounded below by zero and right-tailed, making a log-normal model more appropriate.

From these confidence intervals, the pruner 120 constructs a bounding box 530 in the objective space. The bounding box 530 has an upper-left corner point p defined by the upper bound of the accuracy confidence interval and the lower bound of the cost confidence interval. The point p represents the most optimistic plausible outcome for the candidate given the intermediate results observed so far.

The pruner 120 determines whether the upper-left corner point p falls below the current Pareto frontier 510. If upper-left corner point p falls below the Pareto frontier 510 (i.e., it is dominated by one or more points on the frontier), the candidate flow configuration is unlikely to contribute to the Pareto frontier even under the most favorable assumptions, and the pruner 120 terminates the evaluation. Computational resources freed by the termination may be allocated to evaluate a different candidate flow configuration. If upper-left corner point p does not fall below the Pareto frontier 510, the evaluation continues with additional evaluation instances, and the intermediate estimates and confidence intervals are recomputed incrementally.

In some embodiments, the pruner 120 may use different distributional models for the confidence intervals, different confidence levels, or may extend the analysis to more than two objective dimensions by constructing a higher-dimensional bounding region and checking dominance against the current Pareto frontier in the higher-dimensional space.

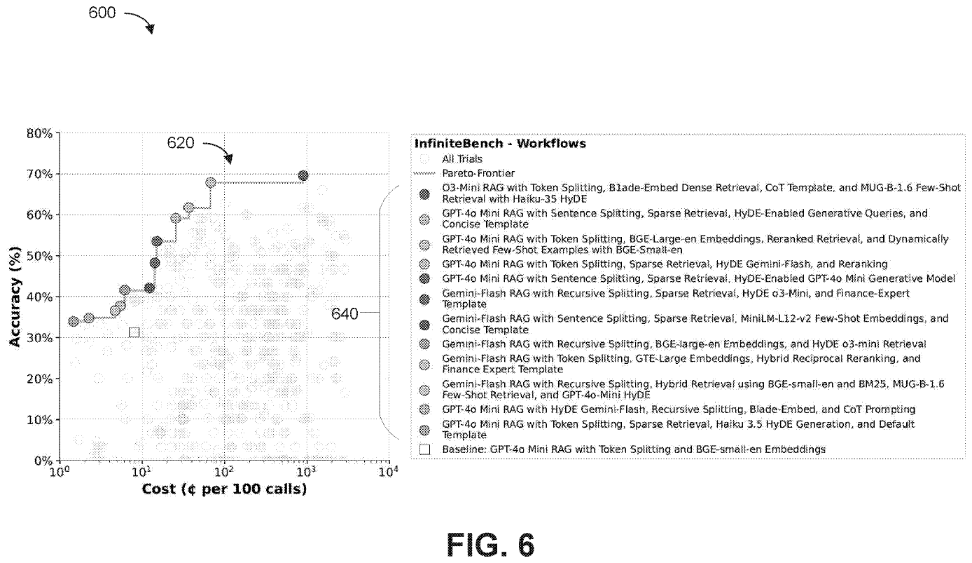

FIG. 6 is a scatter plot 600 illustrating a Pareto frontier of evaluated candidate flow configurations in an accuracy-cost objective space, in accordance with one or more embodiments. FIG. 6 depicts the results of an example multi-objective optimization run performed by the optimizer system 110.

The scatter plot 600 represents an accuracy-versus-cost objective space with a task accuracy axis (vertical, measured in percent) and a cost axis (horizontal, measured in cost units per batch of queries, shown on a logarithmic scale). Each point in the scatter plot represents an evaluated candidate flow configuration, with its position determined by the objective values obtained during evaluation.

The majority of evaluated candidates appear as dominated points, shown in a faint, neutral color. These configurations are dominated by at least one other configuration that achieves both higher accuracy and lower cost (or equal on one and better on the other).

A Pareto frontier 620 is shown as a set of Pareto-optimal points connected by a stepped line. Each point on the Pareto frontier 620 represents a non-dominated flow configuration; that is, no other evaluated configuration achieves simultaneously higher accuracy and lower cost.

Individual Pareto-optimal configurations on the frontier may be annotated with their key functional facility selections, such as the synthesizing LLM, text splitter type, retriever type, and any optional functional facilities (e.g., HyDE, reranking, few-shot prompting). A baseline configuration, corresponding to a commonly used default configuration, may also be shown for comparison. The Pareto frontier 620 allows a practitioner to identify configurations that outperform the baseline at the same cost, or that match the baseline accuracy at reduced cost.

A selected configuration 640 is highlighted on the Pareto frontier 620, representing the Pareto-optimal flow configuration selected for deployment. The selection may be based on user-specified constraints provided through the user interface 172 of the client device 170, such as a maximum cost budget or a minimum accuracy requirement. The optimizer system 110 may configure a generative AI pipeline in accordance with the selected configuration 640.

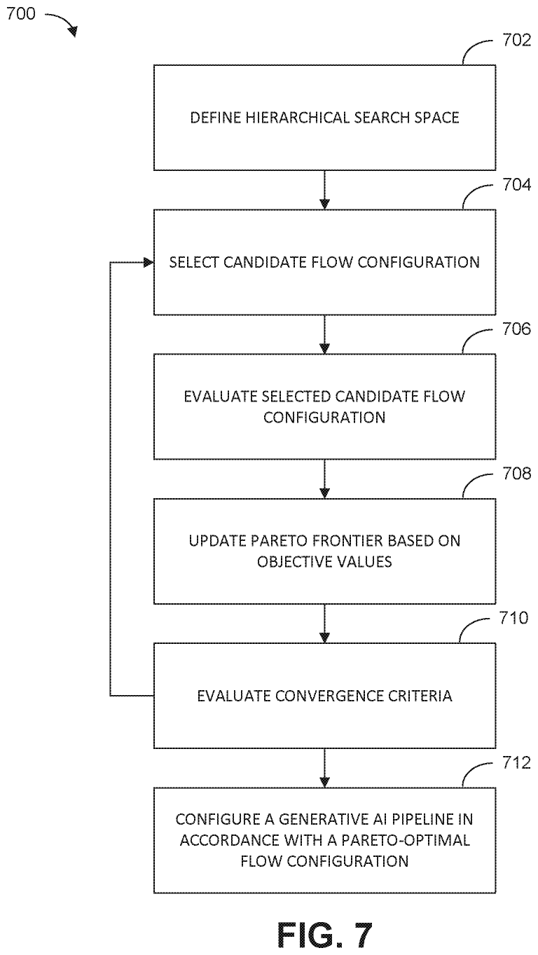

FIG. 7 is a flowchart of an example process 700 for identifying high-performing (e.g., optimal, Pareto-optimal, etc.) generative AI flow configurations using multi-objective Bayesian optimization, in accordance with one or more embodiments. The process 700 may be performed by the optimizer system 110 of FIG. 1 and thus may be a computer-implemented method.

At operation 702, the search space manager 112 obtains a search space including a plurality of candidate generative AI flow configurations. Each candidate flow configuration specifies a flow type selected from a set of flow types and a set of hyperparameters based on the selected flow type. The hyperparameters may specify one or more functional facility selections for the candidate flow configuration. The structure of the hierarchical search space is described in detail with reference to FIG. 4.

In some embodiments, before operation 702, the seeding engine 122 seeds the candidate selector 114 with a set of initial flow configurations and their objective values. The set of initial flow configurations may include a set of standard flow configurations obtained by enumerating combinations of selected functional facility choices. For example, the seeding engine 122 may systematically iterate over combinations of synthesizing LLMs and embedding models with default settings for remaining functional facilities to produce a set of commonly used baseline configurations. In some embodiments, the set of initial flow configurations include randomly sampled flow configurations from the hierarchical search space. In some embodiments, the seeding engine 122 seeds the optimization with objective values obtained from a prior optimization performed on a different dataset.

At operation 704, the candidate selector 114 selects a candidate flow configuration to evaluate based on previously obtained objective values. The candidate selector 114 may use MO-TPE with an EHVI acquisition function. For the first iteration (when no prior objective values exist beyond any seed values), the candidate selector 114 may select a candidate by random sampling from the hierarchical search space. For subsequent iterations, the candidate selector 114 may use the accumulated objective values from prior evaluations to model the search space and select a candidate in a region likely to improve the Pareto frontier.

At operation 706, the flow evaluator 116 evaluates the selected candidate flow configuration against a plurality of objective functions to obtain a set of objective values for the selected candidate flow configuration. The flow evaluator 116 instantiates the candidate flow by assembling the selected functional facilities with their associated hyperparameters and processes an evaluation dataset including a plurality of evaluation instances (e.g., questions and answers). The objective functions may include task accuracy and operational cost. The objective functions may additionally or alternatively include latency, reliability, throughput, or fairness, among others. The evaluation process may be subject to early stopping by the pruner 120, as described in detail with reference to FIGS. 5 and 8.

At operation 708, the frontier manager 118 updates a Pareto frontier based on the set of objective values obtained for the evaluated candidate flow configuration. The Pareto frontier includes a set of non-dominated flow configurations with respect to the plurality of competing objective functions. If the newly evaluated configuration is non-dominated (i.e., no configuration currently on the frontier achieves simultaneously better values on all objectives), it is added to the frontier. Any previous frontier configurations that are now dominated by the new configuration may be removed.

At operation 710, the candidate selector 114 determines whether a convergence criterion has been met. The convergence criterion may be based on a maximum number of iterations, a computational budget, a time limit, or a determination that the Pareto frontier has stabilized (e.g., no new non-dominated configurations have been found for a threshold number of consecutive iterations), among others. If the convergence criterion is not met, the process 700 returns to operation 704 to select and evaluate another candidate. If the convergence criterion is met, the process 700 proceeds to operation 712.

At operation 712, the optimizer system 110 configures a generative AI pipeline in accordance with a high-performing flow configuration (e.g., a Pareto-optimal flow configuration selected from the Pareto frontier). The selection may be made by a user through the user interface 172 of the client device 170 based on inspection of the Pareto frontier (e.g., visualized in FIG. 6), or may be made automatically based on user-specified constraints such as a maximum cost budget or a minimum accuracy threshold. Configuring the pipeline may include instantiating the flow with the functional facility selections and hyperparameters specified by the selected configuration and connecting the instantiated flow to the modeling engine 150 for production use. Configuring the pipeline may also or instead include providing the functional facility selections and hyperparameters specified by the selected configuration for the user's device to coordinate instantiation of the flow.

FIG. 8 is a flowchart of an example process 800 for evaluating candidate generative AI flow configurations, in accordance with one or more embodiments. The process 800 may be invoked as part of operation 706 or may be performed independently within any multi-objective optimization process that maintains a Pareto frontier.

At operation 802, the flow evaluator 116 evaluates a candidate flow configuration by processing one or more evaluation instances against the candidate flow configuration. Processing each evaluation instance may produce an accuracy score and a cost value for the evaluation instance. Each evaluation instance may include a question-answer pair. Processing a given evaluation instance may include generating a response to the question of the question-answer pair using the candidate flow configuration and scoring the generated response against the answer of the question-answer pair using a judge language model (e.g., LLM) to produce the accuracy score. The judge language model may be randomly selected for each evaluation instance from a set of available judge language models of the modeling engine 150.

When cost is an evaluated metric, the cost value for each evaluation instance includes the aggregate cost of model invocations performed during processing of that instance. For a candidate flow configuration specifying a RAG pipeline, the cost value may include costs associated with calls to any one or more of the embedding model (for encoding the query), the synthesizing language model (for generating the response), a reranking model (if the configuration includes reranking), or a HyDE model (if the configuration includes hypothetical document generation), among others.

At operation 804, after processing fewer than all of the evaluation instances, the pruner computes intermediate objective estimates for the candidate flow configuration. The intermediate objective estimates may include an accuracy estimate and a corresponding accuracy confidence interval derived from the accuracy scores of the processed evaluation instances, and a cost estimate and a corresponding cost confidence interval derived from the cost values of the processed evaluation instances.

The accuracy confidence interval may be computed by fitting a normal distribution to the accuracy scores. The upper bound of the accuracy confidence interval is a+z√(a(1−a)/N). The cost confidence interval is computed by fitting a log-normal distribution to the cost values. The cost estimate includes a percentile-based cost statistic, such as the P80 cost. The lower bound of the cost confidence interval is c−z(σ_c/√L). The confidence level may be at least 90%.

The intermediate objective estimates may be updated incrementally as each successive evaluation instance is processed so the pruner 120 can re-evaluate the pruning decision after each new data point. Embodiments are not limited to accuracy and cost metrics.

At operation 806, the pruner 120 computes a bounding box 530 in the multi-objective space from the accuracy confidence interval and the cost confidence interval. The bounding box 530 has an upper-left corner point p 532 defined by the upper bound of the accuracy confidence interval and the lower bound of the cost confidence interval. The upper-left corner point p 532 represents the most optimistic plausible outcome for the candidate flow configuration given the intermediate results.

At operation 808, the pruner 120 determines whether the upper-left corner point p 532 of the bounding box 530 falls below a current Pareto frontier maintained by the multi-objective optimization process. The current Pareto frontier is maintained by the frontier manager 118 and includes the set of non-dominated flow configurations identified so far.

If the upper-left corner point p 532 does not fall below the current Pareto frontier, the process 800 returns to operation 804 to compute the intermediate objective estimates of additional evaluation instances and re-evaluate the pruning decision.

If the upper-left corner point p 532 falls below the current Pareto frontier, the process 800 proceeds to operation 810.

At operation 810, the pruner 120 terminates the evaluation of the candidate flow configuration before all of the evaluation instances have been processed.

At operation 812, the optimizer system 110 allocates computational resources freed by the termination to evaluate a different candidate flow configuration in the multi-objective optimization process. For example, in embodiments using the compute cluster of FIG. 3, the compute node that was processing the terminated evaluation may be reassigned to begin evaluating the next candidate selected by the candidate selector 114.

In some embodiments, the flow evaluator 116 caches intermediate evaluation results associated with shared sub-computations across candidate flow configurations. For example, if two candidate configurations share the same embedding model and text splitter settings, the vector embeddings computed for the grounding corpus by the first configuration may be cached and reused by the second configuration. This avoids redundant computation and reduces the overall cost of the optimization process.

Some examples have been described in which an optimizer system 110 systematically searches within a set of potential AI flow configurations for the best generative AI flow configurations for a particular set of constraints and/or objectives. In some examples, the set of potential AI flow configurations include RAG-based flow configurations (e.g., agentic and/or non-agentic RAG-based flow configurations). In some examples, RAG-based flow configurations can include GraphRAG flows, self-reflective RAG flows, hybrid/modular RAG flows, multimodal RAG flows, adaptive RAG flows, HyDE (hypothetical document embeddings) RAG flows, corrective RAG (CRAG) flows, etc. Additionally or alternatively, the potential AI flow configurations can include other flow configurations (e.g., non-RAG-based flow configurations) including, without limitation agentic AI flows (autonomous agents), multi-agent systems (MAS), cache-augmented generation (CAG) flows, knowledge-augmented generation (KAG) flows, reflexive flows, guardrail-protected flows, non-agentic (e.g., single-shot or user-driven) flows, agentic (e.g., multi-step, tool-using) flows, fully autonomous flows, user-created flows, etc.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities. In some implementations, all functionality may be implemented in a single functional facility. It should also be appreciated that, in some implementations, some of the functional facilities described herein may be implemented together with or separately from others (i.e., as a single unit or separate units), or some of these functional facilities may not be implemented.

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner, including as computer-readable storage media of a computing device 900) or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

In some, but not all, implementations in which the techniques may be embodied as computer-executable instructions, these instructions may be executed on one or more suitable computing device(s) operating in any suitable computer system, including the exemplary computer system of FIG. 9, or one or more computing devices (or one or more processors of one or more computing devices) may be programmed to execute the computer-executable instructions. A computing device or processor may be programmed to execute instructions when the instructions are stored in a manner accessible to the computing device/processor, such as in a local memory (e.g., an on-chip cache or instruction register, a computer-readable storage medium accessible via a bus, a computer-readable storage medium accessible via one or more networks and accessible by the device/processor, etc.). Functional facilities that comprise these computer-executable instructions may be integrated with and direct the operation of a single multi-purpose programmable digital computer apparatus, a coordinated system of two or more multi-purpose computer apparatuses sharing processing power and jointly carrying out the techniques described herein, a single computer apparatus or coordinated system of computer apparatuses (co-located or geographically distributed) dedicated to executing the techniques described herein, one or more Field-Programmable Gate Arrays (FPGAs) for carrying out the techniques described herein, or any other suitable system.

FIG. 9 illustrates one exemplary implementation of a computing device 900 that may be used in a system implementing the techniques described herein, although others are possible. It should be appreciated that FIG. 9 is intended neither to be a depiction of necessary components for a computing device to operate in accordance with the principles described herein, nor a comprehensive depiction.

Computing device 900 may include at least one processor 902, a network adapter 904, and computer-readable storage media 906. Computing device 900 may be, for example, a desktop or laptop personal computer, a personal digital assistant (PDA), a smart mobile phone, a server, a wireless access point or other networking element, or any other suitable computing device. Network adapter 904 may be any suitable hardware and/or software to enable the computing device 900 to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media 906 may be adapted to store data to be processed and/or instructions to be executed by one or more processors 902. Processor 902 enables processing of data and execution of instructions. The data and instructions may be stored on the computer-readable storage media 906, which may be a non-transitory computer-readable medium.

The data and instructions stored on computer-readable storage media 906 may include computer-executable instructions implementing techniques which operate according to the principles described herein. In the example of FIG. 9, computer-readable storage media 906 stores computer-executable instructions implementing various facilities and storing various information as described above. Computer-readable storage media 906 may store the various processes/facilities discussed above (e.g., with regard to FIG. 1). Accordingly, one or more of the methods described herein may be computer-implemented.

While not illustrated in FIG. 9, a computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

### Terminology

The terminology used herein is for the purpose of description and should not be regarded as limiting.

The term “approximately,” the phrase “approximately equal to,” and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

Measurements, sizes, amounts, etc. may be presented herein in a range format. The description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as 10-20 inches should be considered to have specifically disclosed subranges such as 10-11 inches, 10-12 inches, 10-13 inches, 10-14 inches, 11-12 inches, 11-13 inches, etc.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed is:

1. A computer-implemented method, comprising:
performing multi-objective optimization over a hierarchically-organized search space comprising a plurality of candidate generative AI flow configurations.

2. The method of claim 1, wherein performing the multi-objective optimization comprises performing multi-objective Bayesian optimization.

3. The method of claim 1, wherein:
each candidate generative AI flow configuration comprises a flow type selected from a set of flow types and a set of hyperparameters based on the flow type; and
performing the multi-objective optimization over the hierarchically-organized search space comprises:
iteratively selecting a candidate flow configuration to evaluate based on previously obtained objective values, and evaluating the selected candidate flow configuration against a plurality of objective functions to generate a set of objective values for the selected candidate flow configuration;
updating a frontier based on the set of objective values generated for each evaluated candidate flow configuration; and
configuring a generative AI pipeline in accordance with a flow configuration selected from the frontier.

4. The method of claim 3, wherein the set of flow types comprises at least one non-agentic flow type and at least one agentic flow type, and wherein a candidate flow configuration of the agentic flow type incorporates a candidate flow configuration of the non-agentic flow type as a subroutine.

5. The method of claim 3, wherein the hyperparameters specify a plurality of facility selections for the candidate generative AI flow configuration.

6. The method of claim 5, wherein the plurality of facility selections comprises any one or more of a language model selection, an embedding model selection, or a retriever type selection.

7. The method of claim 3, wherein the frontier comprises a set of non-dominated flow configurations with respect to the plurality of objective functions.

8. The method of claim 3, wherein the plurality of objective functions comprises task accuracy and operational cost.

9. The method of claim 3, further comprising, prior to optimizing, seeding the optimization with a set of initial flow configurations, the set of initial flow configurations comprising any one or more of (i) a set of standard flow configurations obtained by enumerating combinations of selected facility choices or (ii) a set of randomly sampled flow configurations from the search space.

10. The method of claim 3, further comprising, prior to optimizing, seeding the optimization with objective values obtained from a prior optimization.

11. The method of claim 3, wherein evaluating the selected candidate flow configuration comprises:
computing intermediate objective estimates for the candidate flow configuration based on a plurality of evaluation instances;
computing a bounding box in a multi-objective space based on the intermediate objective estimates, the bounding box having an upper-left corner point;
determining whether the upper-left corner point of the bounding box falls below a current frontier maintained by the optimization; and
responsive to determining that the upper-left corner point falls below the current frontier, terminating the evaluating of the candidate flow configuration before all of the plurality of evaluation instances have been processed.

12. The method of claim 11, wherein the intermediate objective estimates comprises (i) an accuracy estimate and a corresponding accuracy confidence interval derived from accuracy scores of the processed evaluation instances, and (ii) a cost estimate and a corresponding cost confidence interval derived from cost values of the processed evaluation instances.

13. The method of claim 12, wherein the bounding box is computed from the accuracy confidence interval and the cost confidence interval.

14. The method of claim 13, wherein the upper-left corner point of the bounding box is defined by an upper bound of the accuracy confidence interval and a lower bound of the cost confidence interval.

15. The method of claim 12, wherein computing the intermediate objective estimates comprises updating the accuracy estimate and the cost estimate incrementally as each successive evaluation instance is processed.

16. The method of claim 12, wherein each evaluation instance comprises a question-answer pair, and wherein processing a given evaluation instance comprises:
generating a response to a question of the question-answer pair using the candidate flow configuration; and
scoring the generated response against an answer of the question-answer pair using a judge language model to produce the accuracy score for the given evaluation instance.

17. The method of claim 11, further comprising:
allocating computational resources freed by the terminating to evaluate a different candidate flow configuration in the optimization.

18. The method of claim 13, further comprising, responsive to determining that the upper-left corner point of the bounding box does not fall below the current frontier, continuing the evaluating of the candidate flow configuration by processing additional evaluation instances.

19. The method of claim 3, wherein performing the multi-objective optimization further comprises:
partitioning the hyperparameters into a plurality of blocks, each block comprising a subset of the hyperparameters;
sequentially optimizing the plurality of blocks, wherein optimizing each block comprises performing multi-objective optimization over the hyperparameters of that block while maintaining hyperparameter values in remaining blocks; and
setting hyperparameter values for a subsequent block based on the objective values of a prior block.

20. The method of claim 19, wherein sequentially optimizing the plurality of blocks comprises adding hyperparameters of a subsequent block to hyperparameters of a prior block.

21. The method of claim 19, wherein setting hyperparameter values for a subsequent block based on the objective values of a prior block comprises:
identifying a knee point on the frontier after optimizing the prior block; and
setting the hyperparameter values at the knee point for the hyperparameters of the subsequent block.

22. The method of claim 19, wherein hyperparameters associated with each block correspond to a common stage of a generative AI flow configuration, and wherein the plurality of blocks comprises any one or more of:
a retrieval block comprising hyperparameters related to retrieval-augmented generation;
a prompting block comprising hyperparameters related to prompt configuration; and
a synthesis block comprising hyperparameters related to response generation.

23. The method of claim 19, wherein at least one block is hierarchically organized into a plurality of sub-blocks, each sub-block comprising a subset of hyperparameters of that block, and wherein optimizing that block comprises sequentially optimizing the plurality of sub-blocks.

24. A computing device, comprising:
a processor; and
a non-transitory computer-readable medium storing instructions that, when executed by the processor, causes the processor to perform operations comprising:
obtaining a search space comprising a plurality of candidate generative AI flow configurations, wherein each candidate generative AI flow configuration comprises a flow type selected from a set of flow types and a set of hyperparameters based on the selected flow type;
performing multi-objective Bayesian optimization over the search space by iteratively (i) selecting a candidate flow configuration to evaluate based on previously obtained objective values, and (ii) evaluating the selected candidate flow configuration against a plurality of objective functions to generate a set of objective values for the selected candidate flow configuration;
updating a frontier based on the set of objective values generated for each evaluated candidate flow configuration; and
configuring a generative AI pipeline in accordance with a flow configuration selected from the frontier.

25. A non-transitory computer-readable medium storing instructions that, when executed by a processor, causes the processor to perform operations comprising:
obtaining a search space comprising a plurality of candidate generative AI flow configurations, wherein each candidate generative AI flow configuration comprises a flow type selected from a set of flow types and a set of hyperparameters based on the selected flow type;
performing multi-objective Bayesian optimization over the search space by iteratively (i) selecting a candidate flow configuration to evaluate based on previously obtained objective values, and (ii) evaluating the selected candidate flow configuration against a plurality of objective functions to generate a set of objective values for the selected candidate flow configuration;
updating a frontier based on the set of objective values generated for each evaluated candidate flow configuration; and
configuring a generative AI pipeline in accordance with a flow configuration selected from the frontier.
